(19) United States
(12) Patent Application Publication
(10) Pub. No.: US 2021/0105263 A1
(43) Pub. Date: Apr. 8, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Fumihisa SUZUKI, Kanagawa (JP)

(73) Assignee: FUJI XEROX CO., LTD., Tokyo (JP)

(21) Appl. No.: 16/890,369

(22) Filed: Jun. 2, 2020

(30) Foreign Application Priority Data
Oct. 4, 2019 (JP) 2019-184050

(51) Int. Cl. H04L 29/06; H04L 29/08

(52) U.S. Cl. CPC H04L 63/0807; H04L 63/0853; H04L 67/02; H04L 63/123; H04L 63/108

(57) ABSTRACT

An information processing apparatus includes a memory and a processor. The memory stores management information and a refresh token in an associated form. The management information is associated with a user and the refresh token serves as second qualification information that is used to acquire an access token serving as first qualification information for use of a web service. The processor is configured to accept the management information, transmit to an authentication server the refresh token associated with the accepted management information and stored on the memory, receive the access token that is transmitted from the authentication server if the authentication server has verified that the transmitted refresh token is effective, and use the web service with the received access token.

### CROSS-REFERENCE TO RELATED APPLICATIONS

This application is based on and claims priority under 35 USC 119 from Japanese Patent Application No. 2019-184050 filed Oct. 4, 2019.

### BACKGROUND

### (i) Technical Field

The present disclosure relates to an information processing system, an information processing apparatus, and a non-transitory computer readable medium.

### (ii) Related Art

When a user is authenticated by an authentication server, the authentication server may provide the user with an access token serving as qualification information used to use a web service. The user is thus permitted to use the web service with the access token.

U.S. Pat. No. 9,148,548 discloses a multi-function apparatus that stores an access token serving as qualification information used to use a web service. The web service is then used using the access token.

An access token to use a web service may be stored on an apparatus that is used to the web service. The access token may remain stored on the apparatus even while the apparatus is not used. When the web service is used, the access token stored on the apparatus is used. A user, once registered in an authentication server, may possibly cease to be registered later in the authentication server. In such a case, even if the user is no longer authenticated by the authentication server, the user may still be able to use the web using the access token stored on the apparatus.

### SUMMARY

Aspects of non-limiting embodiments of the present disclosure relate to providing a mechanism that precludes the use of a web service when a user associated with a token is not authenticated by an authentication server even if an information processing apparatus has stored since the authentication of the user the token serving as information used to use the web service.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a memory and a processor. The memory is configured to store management information and a refresh token in an associated form. The management information is associated with a user and the refresh token serves as second qualification information that is used to acquire an access token serving as first qualification information for use of a web service. The processor is configured to accept the management information, transmit to an authentication server the refresh token associated with the accepted management information and stored on the memory, receive the access token that is transmitted from the authentication server if the authentication server has verified that the transmitted refresh token is effective, and use the web service with the received access token.

### BRIEF DESCRIPTION OF THE DRAWINGS

Exemplary embodiment of the present disclosure will be described in detail based on the following figures, wherein:

FIG. 1 is a block diagram illustrating a configuration of an information processing system of the exemplary embodiment;

FIG. 2 is a block diagram illustrating a hardware configuration of a terminal apparatus of the exemplary embodiment;

FIG. 3 is a functional block diagram illustrating the terminal apparatus of the exemplary embodiment;

FIG. 4 is a block diagram illustrating a configuration of an authentication server of the exemplary embodiment;

FIG. 5 is a flowchart illustrating an authentication process;

FIG. 6 is a flowchart illustrating a process of using a web service;

FIG. 7 illustrates the authentication process; and

FIG. 8 illustrates the authentication process.

### DETAILED DESCRIPTION

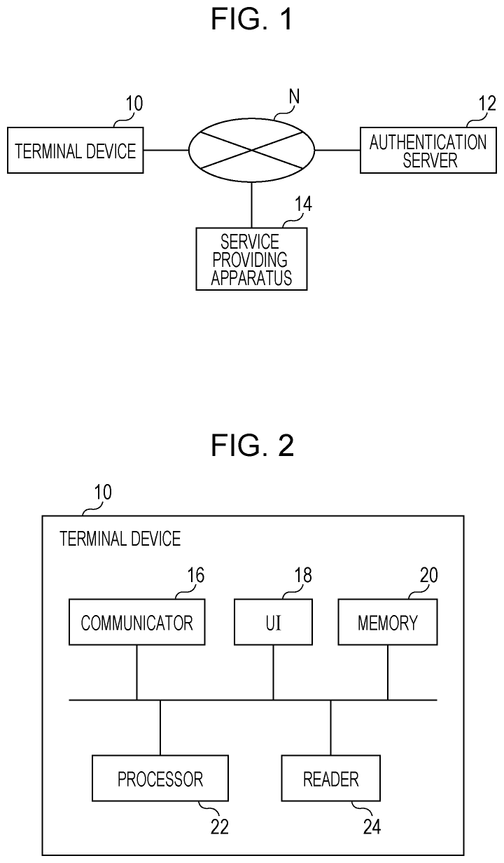

An information processing system of an exemplary embodiment of the disclosure is described below with reference to FIG. 1. FIG. 1 is a block diagram illustrating a configuration of the information processing system.

The information processing system of the exemplary embodiment includes one or more terminal apparatuses 10, authentication server 12, and service providing apparatus 14.

Each of the terminal apparatus 10, authentication server 12, and service providing apparatus 14 has a communication function with another apparatus. The communication with another apparatus may be a wired communication using a cable or radio communication. Each apparatus may be physically coupled to another apparatus via a cable to exchange information or wirelessly coupled to another apparatus to exchange information. Near field communication (NFC) or Wi-Fi (registered trademark) may be used as the radio communication. Radio communication other than these standards may also be used. For example, Bluetooth (registered trademark) or radio frequency identifier (RFID) may be used as NFC. Each apparatus may communicate with another apparatus via a communication network N, such as a local-area network (LAN) or the Internet.

The terminal apparatus 10 is used by a user. For example, the terminal apparatus 10 may be a personal computer (PC), tablet PC, smart phone, cellular phone, image processing apparatus or another apparatus. The image processing apparatus may a multi-function apparatus that has a scan function, print function, copy function and/or fax function. The terminal apparatus 10 may be an apparatus other than this apparatus.

The authentication server 12 is configured to authenticate each user. If the user is successfully authenticated, the authentication server 12 outputs an access token and a refresh token. The access token is first qualification information used to use a web service provided by the service providing apparatus 14. The refresh token is second qualification information used to acquire the access token. For example, the authentication server 12 is an open identity (ID) provider.

The access token is information that indicates that a user is permitted to use the web service. For example, the access token is a unique character string that includes a line of random alphanumerical characters. An expiration date of an effective period may be set on the access token. The user is not permitted to use the web service with an expired access token. The access token may be tagged with electronic signature.

The refresh token is information that indicates that the user has been permitted to obtain the access token. For example, the refresh token is a unique character string that includes a line of random alphanumerical characters. Even if the access token has been expired, the refresh token may be used to update the access token to obtain an updated access token. An expiration date of an effective period may be set on the refresh token. The user is not permitted to obtain the access token with an expired refresh token.

If an expiration date is set on each of the access token and refresh token, the refresh token is set to be longer in effective period than the access token. For example, an effective period as long as about 1 month may be set on the refresh token and an effective period as long as several minutes, several hours, or several days may be set on the access token. These effective periods are quoted as examples only.

Upon receiving the refresh token from the terminal apparatus 10, the authentication server 12 updates the access token associated with the received refresh token and transmits to the terminal apparatus 10 the updated access token and a new refresh token to further update the updated access token. The terminal apparatus 10 is permitted to use the web service using the updated access token. When the access token is updated, the older access token prior to the update is invalidated and the user is not permitted to use the web service with the older access token. The older refresh token used to update the access token is invalidated and the user is not permitted to update the access token with the older refresh token.

The service providing apparatus 14 is configured to provide the web service. The web services may include a service of providing an application on a network, such as the Internet, service of providing video or music on a web mail, social networking service (SNS), or the Internet, service of selling or reserving a product on the Internet, search service on the Internet, service of providing information on the Internet, and service of providing a settlement mechanism on the Internet. Other web services may also be provided by the service providing apparatus 14.

The user is permitted to use, with the access token, the web service provided by the service providing apparatus 14. The access token may be different from web service to web service. In such a case, the user is permitted to use the web service associated with the access token provided to the user.

The hardware configuration of the terminal apparatus 10 is described with reference to FIG. 2. FIG. 2 is a block diagram illustrating the hardware configuration of the terminal apparatus 10 of the exemplary embodiment.

The terminal apparatus 10 includes a communicator 16, user interface (UI) 18, memory 20, processor 22, and reader 24. Alternatively, the reader 24 may be configured to be a separate unit, external to the terminal apparatus 10, in the information processing system. If the terminal apparatus 10 is a multi-function apparatus, such as an image processing apparatus, the terminal apparatus 10 may include a scanner that generates image data by optically reading a document and a printer that prints an image on a paper sheet.

The communicator 16 is a communication interface and has a function of transmitting information to and receiving information from another apparatus. The communicator 16 may further have a radio communication function and/or a wired communication function. The communicator 16 may communicate with another apparatus by using near field communication (NFC) or via a communication network, such as local-area network (LAN) and/or the Internet.

The UI 18 is a user interface and includes a display and an operation device. The display may be a liquid-crystal display or an electroluminescent (EL) display. The operation device includes a keyboard, input key, and/or operation panel. The UI 18 may be a touch panel that serves as both the display and the operation panel. The UI 18 may also include a microphone or a speaker that emits sound.

The memory 20 has one or more memory regions that store a variety of information. The memory 20 is a hard-disk drive, random-access memory (RAM), dynamic RAM (DRAM), read-only memory (ROM), optical disk, or another storage device or a combination thereof. One or more memories 20 may be included in the terminal apparatus 10.

The processor 22 is configured to control the operation of each element in the terminal apparatus 10. For example, the processor 22 may communicate with each apparatus using the communicator 16, cause a display of the UI 18 to display information, accept information input via the UI 18, cause the memory 20 to store information, or read information from the memory 20. The processor 22 may include a memory.

The reader 24 is configured to read information from a storage device that stores the information. For example, the reader 24 reads information from an integrated circuit (IC) card. For example, the reader 24 may be a scanner or a camera and read information through an optical process.

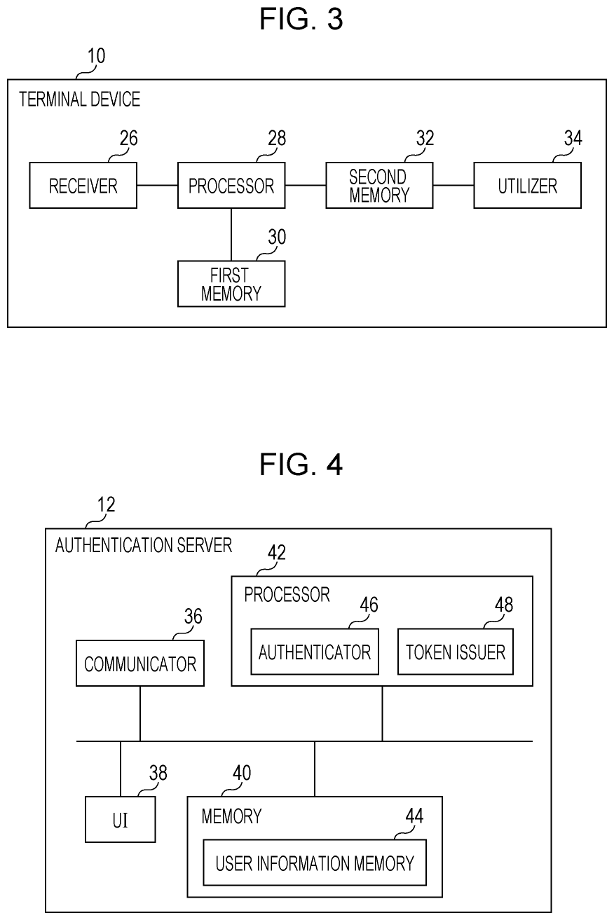

The function of the terminal apparatus 10 is described with reference to FIG. 3. FIG. 3 is a functional block diagram illustrating the terminal apparatus 10 of the exemplary embodiment.

The receiver 26 is configured to accept authentication information. The authentication information is used to authenticate each user on the authentication server 12. The authentication information is user identification information (such as user ID) that uniquely identifies each user. The authentication information includes the user ID and password. User biological information (such as fingerprint, retina, face, blood vessels, or voice).

The processing unit 28 is configured to exchange information with the authentication server 12. For example, the processing unit 28 transmits to the authentication server 12 the authentication information accepted by the receiver 26. The processing unit 28 also receives the access token and the refresh token transmitted from the authentication server 12. The processing unit 28 causes a first memory 30 and second memory 32 to store information.

The first memory 30 serves as a memory area that stores, on a per user basis in an associated form, management information associated with a user, user identification information uniquely identifying the user, and refresh token that the user is permitted to use. For example, the management information is a card identification (ID) that is stored on an IC card associated with the user. The refresh token is retrieved from the authentication server 12. If the biological information is used as the authentication information, the biological information and the refresh token may be stored in an associated form on the first memory 30.

The second memory 32 serves as a memory region that stores the access token and refresh token in association with each other. The access token and the refresh token are retrieved from the authentication server 12.

When the user logs out from the terminal apparatus 10, the access token and refresh token stored on the second memory 32 are deleted. The information stored on the first memory 30 is not deleted.

The utilizer 34 is configured to use the web service with the access token. For example, the utilizer 34 transmits the access token to the service providing apparatus 14. The effectiveness of the access token is verified by the service providing apparatus 14, the authentication server 12, or a combination thereof or another apparatus. If the access token is verified effective, the utilizer 34 is permitted to use the web service provided by the service providing apparatus 14. If the access token is verified as invalid (if the access token is not verified as effective), the utilizer 34 is not permitted to use the web service provided by the service providing apparatus 14.

The receiver 26, processing unit 28 and utilizer 34 are implemented by the processor 22. A memory may be used to implement these elements. The first memory 30 and second memory 32 are memory regions of the memory 20.

Referring to FIG. 4, the configuration of the authentication server 12 is described below. FIG. 4 illustrates the hardware and functional configuration of the authentication server 12.

The authentication server 12 includes a communicator 36, UI 38, memory 40, and processor 42.

The communicator 36 is a communication interface and has a function of transmitting information to and receiving information from another apparatus. The communicator 36 may further have a radio communication function and/or a wired communication function. The communicator 36 may communicate with another apparatus by using near field communication (NFC) or via a communication network, such as local-area network (LAN) and/or the Internet.

The UI 38 is a user interface and includes a display and an operation device. The display may be a liquid-crystal display or an electroluminescent (EL) display. The operation device includes a keyboard, input key, and/or operation panel. The UI 38 may be a touch panel that serves as both the display and the operation panel. The UI 38 may also include a microphone and/or a speaker that emits sound.

The memory 40 has one or more memory regions that store a variety of information. The memory 40 is a hard-disk drive, random-access memory (RAM), dynamic RAM (DRAM), read-only memory (ROM), optical disk, or another storage device or a combination thereof. One or more memories 40 may be included in the authentication server 12.

The processor 42 is configured to control each element in the authentication server 12. For example, the processor 42 may communicate with each apparatus using the communicator 36, cause a display of the UI 38 to display information, accept information input via the UI 38, cause the memory 40 to store information, or read information from the memory 40. The processor 42 may include a memory.

The user information memory 44 is a memory region that stores the authentication information relating to the user registered in the authentication server 12. When the token issuer 48 described below issues the access token and refresh token, the access token and refresh token are associated with the authentication information and then stored on the user information memory 44. The user information memory 44 is a memory region included in memory 40.

The authenticator 46 is configured to authenticate the user with the authentication information. For example, if the authentication information transmitted from the terminal apparatus 10 is stored on the user information memory 44, the authenticator 46 successfully authenticates the user while if the authentication information transmitted from the terminal apparatus 10 is not stored on the user information memory 44, the authenticator 46 results in an unsuccessful authentication.

The token issuer 48 is configured to issue the access token and refresh token. If the user is successfully authenticated in accordance with the authentication information, the token issuer 48 issues the access token and refresh token. The issued access token and refresh token are transmitted from the authentication server 12 to the terminal apparatus 10. The token issuer 48 may set an effective period on the access token. The effective period may be predetermined or set by the administrator. The token issuer 48 may set an effective period on the refresh token. The effective periods of the access token and refresh token may be different or the same. For example, the effective period of the access token may be set to be shorter than the effective period of the refresh token.

The token issuer 48 is configured to update, in accordance with the refresh token, the access token associated with the refresh token and issue an updated access token and a new refresh token to further update the updated access token. The updated access token and the new refresh token are transmitted from the authentication server 12 to the terminal apparatus 10.

If a refresh token is transmitted from the terminal apparatus 10 to the authentication server 12, the token issuer 48 receives the refresh token and verifies the effectiveness of the refresh token. If the authentication information associated with the refresh token is stored on the user information memory 44, the token issuer 48 determines that the refresh token is effective. If the authentication information associated with the refresh token is not stored on the user information memory 44, the token issuer 48 determines that the refresh token is invalid (not effective). If the user registered in the authentication server 12 is set to be invalid or if the user is deleted from the authentication server 12, the authentication information on the user may possibly be deleted from the authentication server 12. Even if the authentication information associated with the refresh token is stored on the user information memory 44, the refresh token may have expired beyond the effective period. In such a case, the token issuer 48 determines that the refresh token is not effective. If the authentication information associated with the refresh token is stored on the user information memory 44 and the refresh token has not expired beyond the effective period, the token issuer 48 determines that the refresh token is effective. If a password included in the authentication information associated with the refresh token is reset, the token issuer 48 may determine that the refresh token is not effective.

If it is verified that the refresh token is effective, the token issuer 48 updates the access token and issues an updated access token and a new refresh token. If the access token is updated, the token issuer 48 invalidates the older access token existing before the updating and the older refresh token used to update the access token.

If it is verified that the refresh token is not effective (invalid), the token issuer 48 neither updates the access token nor issues an updated access token and a new refresh token.

The token issuer 48 is implemented by the processor 42. A memory may be used to implement the token issuer 48.

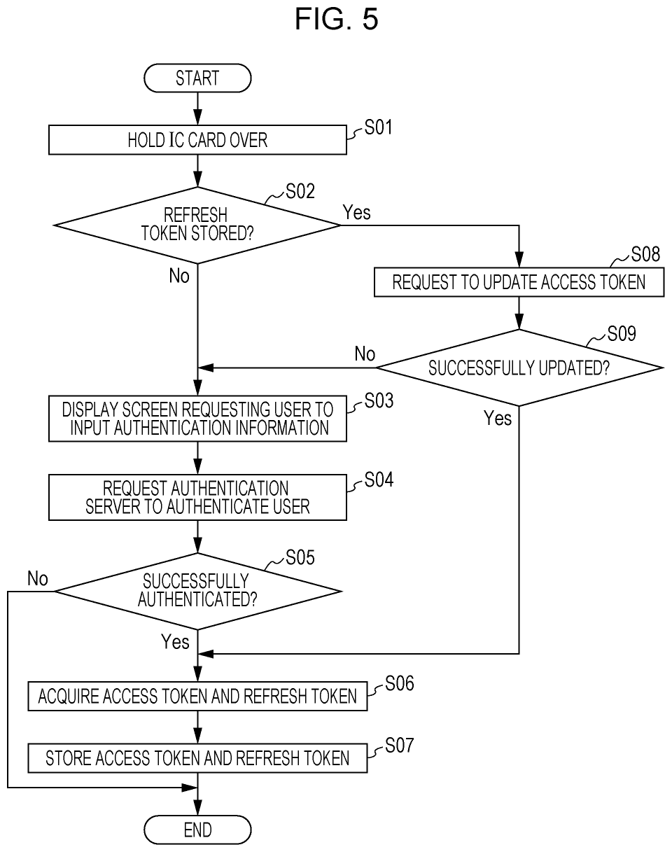

An authentication process is described with reference to FIG. 5. FIG. 5 is a flowchart illustrating the authentication process.

A user holds over the reader 24 an IC card storing a card ID serving as an example of the management information (S01). The reader 24 reads the card ID stored on the IC card. For example, the user holds the IC card over the reader 24 to log in on the terminal apparatus 10.

The processing unit 28 confirms whether user information (such as the user ID) associated with the card ID read from the IC card and the refresh token are stored on the first memory 30. Specifically, the processing unit 28 searches for the user information associated with the card ID read from the IC card and the refresh token.

If the user information associated with the card ID read from the IC card and the refresh token are not stored on the first memory 30 (no path from step S02), the receiver 26 causes a display of the UI 18 to display a screen requesting the user to enter the authentication information to authenticate the user on the authentication server 12 (step S03).

When the user enters the authentication information (for example, the user ID and password) by operating the UI 18, the receiver 26 accepts the authentication information entered by the user. The processing unit 28 transmits to the authentication server 12 the authentication information accepted by the receiver 26 and information requesting the authentication server 12 to authenticate the user (step S04).

The authenticator 46 in the authentication server 12 receives the authentication information from the terminal apparatus 10 and authenticates the user in accordance with the received authentication information. If the authentication information is stored on the user information memory 44, the user may be successfully authenticated. If the authentication information is not stored on the user information memory 44, the authentication may be unsuccessful.

If the authentication is unsuccessful (no path from step S05), the authentication process ends. For example, the authentication server 12 transmits to the terminal apparatus 10 information indicating an unsuccessful authentication. The display of the UI 18 displays information indicating the unsuccessful authentication. In the case of the unsuccessful authentication, the user is not permitted to log in on the terminal apparatus 10. In such a case, the user is not permitted to use a function that is available only after logging in on the terminal apparatus 10.

If the authentication is successful (yes path from step S05), the processing unit 28 acquires the access token to use the web service and the refresh token to update the access token (step S06). Specifically, if the authentication is successful, the token issuer 48 issues the access token to use the web service and the refresh token to update the access token. The authentication server 12 transmits the access token and refresh token to the terminal apparatus 10. The processing unit 28 receives the access token and refresh token from the authentication server 12.

The processing unit 28 causes the memory 20 to store the acquired access token and refresh token (step S07). Specifically, the processing unit 28 causes the first memory 30 to store, in an associated form, the card ID read in step S01, the user identification information (such as the user ID) entered by the user in step S04, and the acquired refresh token. The processing unit 28 causes the second memory 32 to store the acquired access token and refresh token.

If the authentication is successful, the user is permitted to log in on the terminal apparatus 10. The user is thus permitted to use the function that is available only after logging in on the terminal apparatus 10.

When the user logs out from the terminal apparatus 10, the processing unit 28 deletes the access token and refresh token stored on the second memory 32. An ID token indicating that the user has been authenticated by the authentication server 12 may be transmitted from the authentication server 12 to the terminal apparatus 10 and stored on the second memory 32. In such a case, if the user logs out from the terminal apparatus 10, the ID token is also deleted from the second memory 32.

If an instruction to use the web service is given via the UI 18 in the terminal apparatus 10 while the user remains logged in on the terminal apparatus 10, the utilizer 34 uses the web service using the access token stored on the second memory 32.

If the refresh token and the user identification information associated with the card ID are stored on the first memory 30 (yes path from step S02), the processing unit 28 requests, by transmitting to the refresh token to the authentication server 12, the authentication server 12 to update the access token associated with the refresh token (step S08).

Upon receiving the refresh token from the terminal apparatus 10, the token issuer 48 in the authentication server 12 verifies the effectiveness of the refresh token.

If the refresh token is effective, the updating of the access token is successful (yes path from step S09). Specifically, if the refresh token is effective, the token issuer 48 updates the access token associated with the refresh token and issues an updated access token and a new refresh token used to further update the updated access token.

The updated access token and new refresh token are transmitted from the authentication server 12 to the terminal apparatus 10. The processing unit 28 acquire the updated access token and new refresh token (step S06). The processing unit 28 causes the second memory 32 to store the updated access token and new refresh token (step S07). The processing unit 28 deletes or invalidates the refresh token associated with the card ID and user identification information and stored on the first memory 30 and causes the first memory 30 to store the new refresh token in association with the card ID and user identification information (step S07). The utilizer 34 is permitted to use the web service with the updated access token stored on the second memory 32.

If the refresh token is not effective, the updating of the access token is not successful (no path from step S09). Processing proceeds to step S03.

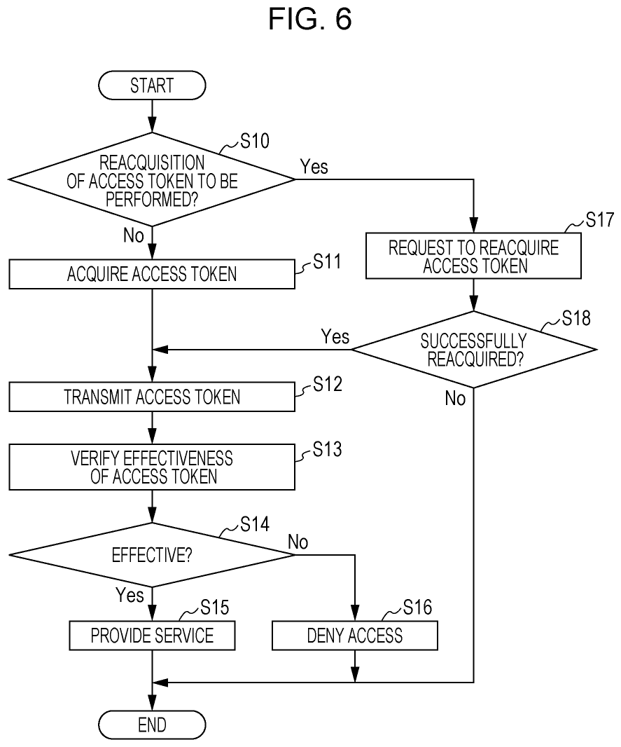

Referring to FIG. 6, the process of using the web service is described. FIG. 6 is a flowchart illustrating the process of using a web service.

If an instruction to use the web service is given by operating the UI 18 in the terminal apparatus 10 while the user remains logged in on the terminal apparatus 10, the utilizer 34 determines whether to reacquire the access token to use the web service. Depending on the specifications of the web service, the access token may be reacquired.

If the access token is not reacquired (no path from step S10), the utilizer 34 retrieves from the second memory 32 the access token to use the web service specified by the user (step S11) and transmits the access token to the service providing apparatus 14 (step S12).

If the access token is transmitted from the terminal apparatus 10 to the service providing apparatus 14, the effectiveness of the access token is verified (step S13). The effectiveness of the access token may be verified by the service providing apparatus 14, the authentication server 12, both the service providing apparatus 14 and the authentication server 12, or another apparatus.

The service providing apparatus 14 requests from the authentication server 12 the access token and information indicating a request for the verification of the effectiveness of the access token. Upon receiving the access token from the service providing apparatus 14, the authenticator 46 in the authentication server 12 verifies the effectiveness of the access token. For example, if the access token has not expired beyond the effective period, the authenticator 46 determines that the access token is effective. If the access token has expired beyond the effective period, the authenticator 46 determines that the access token is not effective. In another example, if the access token is tagged with an electronic signature, the authenticator 46 may determine that the access token is effective. If the access token is not tagged with an electronic signature, the authenticator 46 may determine that the access token is not effective. The authenticator 46 may transmit to the service providing apparatus 14 information indicating the results of the verification of the effectiveness (information indicating whether the access token is effective). This process may be performed by the service providing apparatus 14.

If the access token is effective (yes path from step S14), the service providing apparatus 14 provides to the terminal apparatus 10 the web service that is used by using the access token (step S15).

If the access token is not effective (no path from step S14), the service providing apparatus 14 does not provide to the terminal apparatus 10 the web service that is used by using the access token (step S16).

If the access token is to be reacquired (yes path from step S10), the processing unit 28 transmits to the authentication server 12 the access token and scope information and requests the authentication server 12 to reacquire the access token (step S17). The scope information indicates the function of the web service as a target and the access token to be reacquired is used to use the function of the web service. In accordance with the refresh token and scope information transmitted from the terminal apparatus 10, the authentication server 12 updates the access token and issues an access token to use the function of the web service. The access token and new refresh token are transmitted from the authentication server 12 to the terminal apparatus 10 and thus received by the terminal apparatus 10.

If the access token has been successfully updated in response to the request to reacquire the access token and the terminal apparatus 10 has reacquired the access token (yes path from step S18), processing proceeds to step S12.

If the access token has not been successfully updated and the terminal apparatus 10 has failed to reacquire the access token (no path from step S18), processing ends.

Depending on the specifications of the web service, operations in steps S10, S17, and S18 are not performed and the web service is used using the access token stored on the second memory 32.

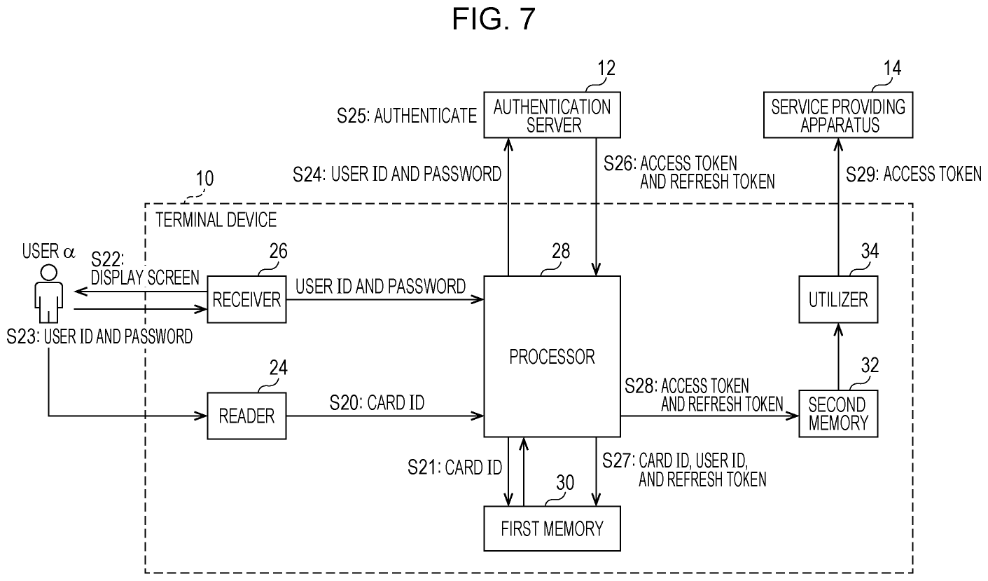

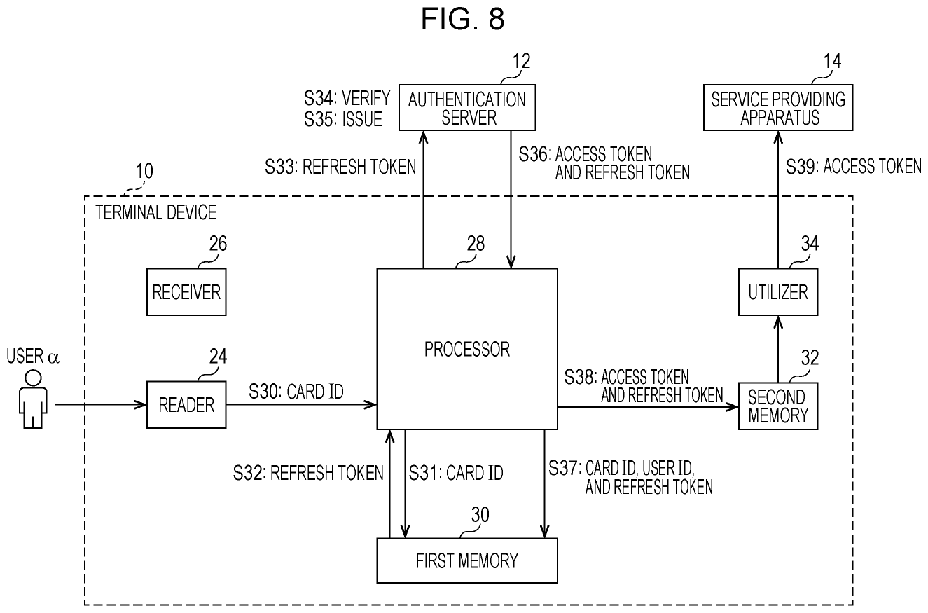

Referring to FIGS. 7 and 8, the authentication process is described in detail. FIGS. 7 and 8 illustrate the authentication process.

Referring to FIG. 7, the login process in which a user α logs in on the terminal apparatus 10 is described.

The user α holds the IC card over the reader 24 to log in on the terminal apparatus 10 (step S20). For example, the IC card stores a card ID “11111”. The card ID 11111 is associated with the user α. The card ID 11111 is read from the IC card by holding the IC card over the reader 24.

Using the card ID 11111 read by the reader 24, the processing unit 28 searches for a combination of the user ID and refresh token associated with the card ID 11111 and stored on the first memory 30 (step S21).

It is assumed herein that the combination of the user ID and refresh token associated with the card ID 11111 is not stored on the first memory 30. For example, if the user α logs in on the terminal apparatus 10 for the first time, the combination of the user ID and refresh token associated with the card ID 11111 is not stored on the first memory 30.

If the combination of the user ID and refresh token associated with the card ID 11111 is not stored on the first memory 30, the receiver 26 causes the display in the UI 18 to display a screen requesting the user to enter the authentication information (for example, the user ID and password) used for the authentication server 12 to authenticate the user (step S22).

The user α enters on the display of the UI 18 the user's own authentication information, for example, the user ID user A and password abcde (step S23). The receiver 26 accepts the user ID user A and password abcde and outputs the received authentication information to the processor 28.

The processing unit 28 transmits to the authentication server 12 the user ID user A and password abcde accepted by the receiver 26 and requests the authentication server 12 to authenticate the user α (step S24).

The authenticator 46 in the authentication server 12 receives the user ID user A and password abcde and authenticates the user α in accordance with the received user ID user A and password abcde (step S25). If the combination of the user ID and refresh token associated with the card ID 11111 is stored on the first memory 30, the authentication is successful. If the combination is not stored on the user information memory 44, the authentication is unsuccessful. When the user α is registered in the authentication server 12, the user ID user A and password abcde of the user α are set and stored on the user information memory 44. It is now assumed that the user α is registered in the authentication server 12 and that the user ID user A and password abcde of the user α are stored on the user information memory 44. In such a case, the authentication server 12 will successfully authenticate the user α.

If the authentication server 12 has successfully authenticated the user α, the token issuer 48 issues an access token AT1 to use the web service provided by the service providing apparatus 14 and a refresh token RT1 to update the access token AT1. The token issuer 48 causes the memory 40 to store the access token AT1 and refresh token RT1 in association with each other. The token issuer 48 also causes the user information memory 44 to store the user ID user A and password abcde of the user α in association with each other.

The access token AT1 and refresh token RT1 issued are transmitted from the authentication server 12 to the terminal apparatus 10 (step S26). The processing unit 28 receives the access token AT1 and refresh token RT1. In response to the reception of the access token AT1 and refresh token RT1, the processing unit 28 recognizes that the authentication server 12 has successfully authenticated the user α and thus permits the user α to log in on the terminal apparatus 10. The authentication server 12 may transmit to the terminal apparatus 10 information indicating that the authentication server 12 has successfully authenticated the user α.

If the authentication of the user α on the authentication server 12 has been unsuccessful, the authentication server 12 does not transmit the access token and refresh token to the terminal apparatus 10 and the user α is not permitted to log in on the terminal apparatus 10.

In response to the reception of the access token AT1 and refresh token RT1 from the authentication server 12, the processing unit 28 causes the first memory 30 to store, in an associated form, the card ID 11111 read from the IC card in step S20, the user ID user A entered by the user α in step S23, and the refresh token RT1 (step S27).

The processing unit 28 causes the second memory 32 to store the access token AT1 and refresh token RT1 in association with each other (step S28).

When the web service provided by the service providing apparatus 14 is used, the utilizer 34 transmits the access token AT1 stored on the second memory 32 to the service providing apparatus 14 (step S29). If it is determined that the access token AT1 is effective, the user α is permitted to use on the terminal apparatus 10 the web service provided by the service providing apparatus 14. For example, if the user α gives an instruction to use the web service by operating the UI 18, the utilizer 34 transmits the access token AT1 to the service providing apparatus 14.

When the user α has logged out from the terminal apparatus 10, the processing unit 28 deletes the access token AT1 and refresh token RT1 on the second memory 32. Even if the user α has logged out from the terminal apparatus 10, the combination of the card ID 11111, user ID user A, and refresh token RT1 is not deleted from the first memory 30.

Referring to FIG. 8, a process performed when the user α logs in on the terminal apparatus 10 for the second time is described below.

In order to log in on the terminal apparatus 10, the user α holds his or her own IC card over the reader 24 (step S30). The IC card stores the card ID 11111. By holding the IC card over the reader 24, the card ID 11111 is read from the IC card.

Using as a search key the card ID 11111 read by the reader 24, the processing unit 28 searches for the combination of the user ID and refresh token associated with the card ID 11111 and stored on the first memory 30 (step S31).

If the user α logs in on the terminal apparatus 10 for the second time not for the first time, the user ID user A of the user α and the refresh token are stored in association with the card ID 11111 on the first memory 30. As previously described, if the user α logs in on the terminal apparatus 10 for the first time, the user ID user A is entered in step S23, and in step S27, the card ID 11111, the user ID user A, and the refresh token RT1 transmitted from the authentication server 12 to the terminal apparatus 10 in step S26 are stored in association with each other on the first memory 30.

Since the card ID 11111, user ID user A, and refresh token RT1 are stored in association with each other on the first memory 30, the user ID user A and refresh token RT1 are searched for.

The processing unit 28 retrieves from the first memory 30 the combination of the card ID 11111, user ID user A, and the refresh token RT1 (step S32).

By transmitting the refresh token RT1 to the authentication server 12, the processing unit 28 requests the authentication server 12 to update the access token associated with the refresh token RT1 (step S33).

The token issuer 48 in the authentication server 12 verifies the effectiveness of the refresh token RT1 transmitted from the terminal apparatus 10 (step S34). As previously described, since the user ID user A and password abcde are stored in association with the refresh token RT1 on the user information memory 44, the token issuer 48 determines that the refresh token RT1 is effective. The effective period may be set on the refresh token RT1. If the user ID user A and password abcde are stored in association with the refresh token RT1 on the user information memory 44, and the refresh token RT1 has not expired beyond the effective period, the token issuer 48 determines that the refresh token RT1 is effective. If the refresh token RT1 has expired beyond the effective period, the token issuer 48 determines that the refresh token RT1 is not effective. If the password associated with the refresh token RT1 is reset, the token issuer 48 may determine that the refresh token RT1 is not effective. If the authentication server 12 has set the user α to be an invalid user or if the user α is deleted from the authentication server 12, the user ID user A and password abcde are deleted from the user information memory 44. In such a case, the token issuer 48 determines that the refresh token RT1 is not effective. The user α is thus authenticated using the refresh token RT1.

If the refresh token RT1 is effective, the token issuer 48 issues a new access token AT2 by updating the access token AT1 associated with the refresh token RT1 (step S35). The token issuer 48 issues a new refresh token RT2 to update the access token AT2. The token issuer 48 invalidates the older access token AT1 and the older refresh token RT1. The web service is not used using the invalid access token AT1 and the access token is not updated using the invalid older refresh token RT1. The token issuer 48 stores the new access token AT2 and new refresh token RT2 in association with each other on the memory 40. The token issuer 48 deletes or invalidates the refresh token RT1 associated with the user ID user A and password abcde of the user α and causes the user information memory 44 to store the new refresh token RT2 in association with the user ID user A and password abcde.

The access token AT2 and refresh token RT2 thus issued are transmitted from the authentication server 12 to the terminal apparatus 10 (step S36). The processing unit 28 receives the access token AT2 and refresh token RT2. In response to the reception of the access token AT2 and refresh token RT2, the processing unit 28 recognizes that the authentication server 12 has successfully authenticated the user α and permits the user α to log in on the terminal apparatus 10. Information indicating that the authentication server 12 has successfully authenticated the user a may be transmitted from the authentication server 12 to the terminal apparatus 10.

If the refresh token RT1 is not effective, the token issuer 48 does not update the access token AT1. In such a case, the updated access token and new refresh token are not transmitted from the authentication server 12 to the terminal apparatus 10 and the user a is not permitted to log in on the terminal apparatus 10. For example, information indicating that the refresh token RT1 is not effective is transmitted from the authentication server 12 to the terminal apparatus 10 and information indicating that the authentication is unsuccessful is displayed on the display of the UI 18 in the terminal apparatus 10.

In response to the reception of the access token AT2 and refresh token RT2 from the authentication server 12, the processing unit 28 deletes or invalidates the refresh token RT1 associated with the card ID 11111 and user ID user A and stored on the first memory 30 and causes the first memory 30 to store the new refresh token RT2 in association with the card ID 1111 and user ID user A (step S37).

The processing unit 28 causes the second memory 32 to store the access token AT2 and refresh token RT2 in association with each other (step S38). When the user a logs out from the terminal apparatus 10 after completing the first use of the terminal apparatus 10, the access token AT1 and refresh token RT1 have been deleted from the second memory 32.

When the user α uses the web service provided by the service providing apparatus 14, the utilizer 34 transmits to the service providing apparatus 14 the access token AT2 stored on the second memory 32 (step S39). When it is determined that the access token AT2 is effective, the user α is permitted to use the web service provided by the service providing apparatus 14 on the terminal apparatus 10. For example, if the user α gives an instruction to use the web service by operating the UI 18, the utilizer 34 transmits the access token AT2 to the service providing apparatus 14.

When the user α has logged out from the terminal apparatus 10, the processing unit 28 deletes the access token AT2 and refresh token RT2 stored on the second memory 32. Even when the user α has logged out from the terminal apparatus 10, the combination of the card ID 11111, user ID user A, and refresh token RT2 is not deleted from the first memory 30.

When the user α logs in on the terminal apparatus 10 for the third time or later, the same process as in the second time is performed.

The authentication server 12 may issue the access token different from web service to web service. For example, if the user specifies a target web service by operating the UI 18 after logging in on the terminal apparatus 10, the processing unit 28 transmits to the authentication server 12 information used to identify the web service specified by the user and the refresh token stored in association with the user ID of the user on the first memory 30. The token issuer 48 verifies the effectiveness of the refresh token. If the refresh token is effective, the token issuer 48 issues the access token to use the web service specified by the user. The access token is transmitted from the authentication server 12 to the terminal apparatus 10. The utilizer 34 uses the web service specified by the user using the access token.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a memory configured to store, in an associated form, management information and a refresh token, the management information associated with a user, the refresh token serving as second qualification information that is used to acquire an access token serving as first qualification information for use of a web service; and
a processor configured to
accept the management information,
transmit to an authentication server the refresh token associated with the accepted management information and stored on the memory,
receive the access token that is transmitted from the authentication server if the authentication server has verified that the transmitted refresh token is effective, and
use the web service with the received access token.

2. The information processing apparatus according to claim 1, wherein the processor is further configured to,
if the refresh token associated with the accepted management information is not stored on the memory, cause a display to display a screen that requests the user to enter authentication information for the authentication server to authenticate the user,
accept the authentication information,
transmit the accepted authentication information to the authentication server,
receive the access token and the refresh token that are transmitted by the authentication server if the authentication server has successfully authenticated the user in accordance with the transmitted authentication information,
cause the memory to store in an associated form the accepted management information, the accepted authentication information, and the refresh token received from the authentication server, and
use the web service with the access token received from the authentication server.

3. The information processing apparatus according to claim 1, wherein the processor is further configured to delete the access token from the information processing apparatus if the user has logged out from the information processing apparatus.

4. The information processing apparatus according to claim 2, wherein the processor is further configured to delete the access token from the information processing apparatus if the user has logged out from the information processing apparatus.

5. The information processing apparatus according to claim 1,
wherein the authentication server issues an access token on a per web service basis to use the web service, and
wherein the processor is further configured to
transmit to the authentication server the refresh token and information to identify the web service specified by the user,
receive the access token that is for use of the web service specified by the user and is transmitted by the authentication server if the authentication server has verified that the transmitted refresh token is effective, and
use the web service, specified by the user, with the received access token.

6. An information processing system comprising:
an information processing apparatus; and
an authentication server,
wherein the information processing apparatus includes a first memory and a first processor and the authentication server includes a second processor,
wherein the first memory stores, in an associated form, management information and a refresh token, the management information associated with a user, the refresh token serving as second qualification information that is used to acquire an access token serving as first qualification information for use of a web service;
wherein the first processor is configured to
accept the management information, and
transmit to the authentication server the refresh token associated with the accepted management information and stored on the first memory,
wherein the second processor is configured to
receive the refresh token transmitted from the information processing apparatus,
verify effectiveness of the received refresh token, and
if the received refresh token is effective, transmit the access token to the information processing apparatus, and
wherein the first processor is further configured to
receive the access token transmitted from the authentication server, and
use the web service with the received access token.

7. A non-transitory computer readable medium storing a program causing a computer to execute a process for processing information, the computer including a memory storing, in an associated form, management information and a refresh token, the management information associated with a user, the refresh token serving as second qualification information that is used to acquire an access token serving as first qualification information for use of a web service, the process comprising:
accepting the management information;
transmitting to an authentication server the refresh token associated with the accepted management information and stored on the memory;
receiving the access token that is transmitted by the authentication server if the authentication server has verified that the transmitted refresh token is effective; and
using the web service with the received access token.
